(19) United States
(12) Patent Application Publication
(10) Pub. No.: US 2003/0084447 A1
(43) Pub. Date: May 1, 2003

(54) Apparatus and method for controlling display of electronic program guide information

(76) Inventor: Joo-Yoen Lee, Yongin-si (KR)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/270,063

(22) Filed: Oct. 15, 2002

(30) Foreign Application Priority Data
Oct. 29, 2001 (KR) 2001-66746

(51) Int. Cl. G06F 3/00; H04N 5/445; G06F 13/00

(52) U.S. Cl. 725/44; 725/39; 725/55

(57) ABSTRACT

A method and apparatus for controlling the display of electronic program guide information. In particular, the method and apparatus perform the operations of receiving an electronic program guide signal including information about television programs or events transmitted by television broadcasting signals, managing and storing the information in accordance with a folder arrangement, and displaying the electronic program guide information in the folders selected by the user. According to the embodiments of the present invention, the electronic program guide information is designed to be configured in a directory system, such as a window filing system, and to be displayed in accordance with a user's selection. Therefore, use of the electronic program guide information becomes much more convenient to the user.

This application claims benefit under 35 U.S.C. §119 from Korean Patent Application No. 2001-66746, filed on Oct. 29, 2001, the entire content of which is incorporated herein by reference.

### BACKGROUND OF THE INVENTION

1. Field of the Invention

The present invention relates to a method and apparatus for managing information relating to television programming. More particularly, the present invention relates to a method and apparatus for controlling the display of electronic program guide information, which perform the operations of receiving an electronic program guide signal including information about television programs or events transmitted by television broadcasting signals, storing the electronic program guide information in accordance with a folder structure designed by a user, and displaying the electronic program guide information corresponding to folders selected by the user.

2. Description of the Related Art

As a result of advances in data processing technology, broadcasting stations can now transmit general information related to television programs including video signals, audio signals and various other additional information. A television receiver receives this additional information and utilizes it in response to television viewers' requests.

In an analog broadcasting system, data broadcasting signals including additional information are transmitted in a horizontal synchronization signal region, which does not affect the display on a display screen. Because the additional information is confined to the horizontal synchronization signal region, there are limits to the amount of additional information that can be transmitted. Thus, it is not possible to provide a user with various kinds of information using an analog broadcasting system. However, in a digital broadcasting system, a huge amount of additional information can be provided, and the additional information can be extended to the area of education, games and on-line commerce information, as well as general programming information.

That is, in a digital television broadcast, program information is compressed and multiplied using MPEG standards before it is transmitted. In the MPEG system, it is possible to transmit a program by a program stream or a plurality of multiplied programs by a transport stream. In other words, it is possible to transmit a program or a plurality of multiplied programs on one channel. For example, either a HD (High Definition) rated program or four SD (Standard Definition) rated programs can be transmitted on the same channel.

A digital television capable of receiving digital broadcasting signals can generate an electronic program guide using electronic program guide data information related to broadcasting programs which is included in the additional information broadcast with the digital broadcasting signals.

FIG. 1 shows a conventional method for displaying EPG (Electronic Program Guide) information. According to this conventional method, program guide information is displayed in a time table for a number of fixed channels. Accordingly, a user may need to spend much time to locate information related to programs of interest displayed in the EPG. Namely, the conventional method for displaying EPG information is incapable of reorganizing an EPG display to suit a user's preferences. Therefore, it is inconvenient for a user to use the conventional EPG.

### SUMMARY OF THE INVENTION

To overcome the above-mentioned disadvantages, it is an object of the present invention to provide a method and an apparatus for controlling the display of electronic program guide information by storing electronic program guide information in a memory according to a folder arrangement designed by a user, and displaying EPG information according to the folders selected by the user.

To substantially accomplish this and other objects, the present invention provides a method for controlling the display of electronic program guide information. The method performs the operations of (a) classifying electronic program guide information corresponding to EPG folders that a user assigns and storing the electronic program guide information in a memory; (b) extracting from the memory electronic program guide information included in the EPG folders selected from the EPG menu display; and (c) converting the electronic program guide information extracted in step (b) into a predetermined graphic signal and outputting that signal to the display.

To further accomplish the above and other objects, the present invention provides an apparatus for controlling the display of electronic program guide information, comprising a control unit, a database, a memory and a graphical signal processing unit. The control unit receives electronic program guide information, stores the received electronic program guide information in a database, and classifies the electronic program guide information corresponding to EPG folders based on an EPG directory structure. The control unit also stores the classified electronic program guide information in a memory, and reads out file information included in the EPG folder selected by the user from the memory. The graphic signal processing unit then generates a graphic signal corresponding to the electronic program guide information read out from the memory.

### BRIEF DESCRIPTION OF THE DRAWINGS

The above objects and advantages of the present invention will become more apparent by describing in detail a preferred embodiment thereof with reference to the attached drawings, in which:

FIG. 1 is a conceptual view of a conventional electronic program guide display;

FIG. 2 is a block diagram of an example of an apparatus for controlling the display of electronic program guide information according to an embodiment of the present invention;

FIG. 3 is a flow chart illustrating an example of operations performed by a method for controlling the display of electronic program guide information according to an embodiment of the present invention;

FIG. 4 is a conceptual view illustrating an example of a design of electronic program guide folders in a directory according to an embodiment of the present invention;

FIG. 5 is a conceptual view illustrating an example of folders of each respective channel included in the channel folder shown in FIG. 4; and

FIG. 6 is a conceptual view illustrating an example of a configuration of an electronic program guide display corresponding to a selected folder.

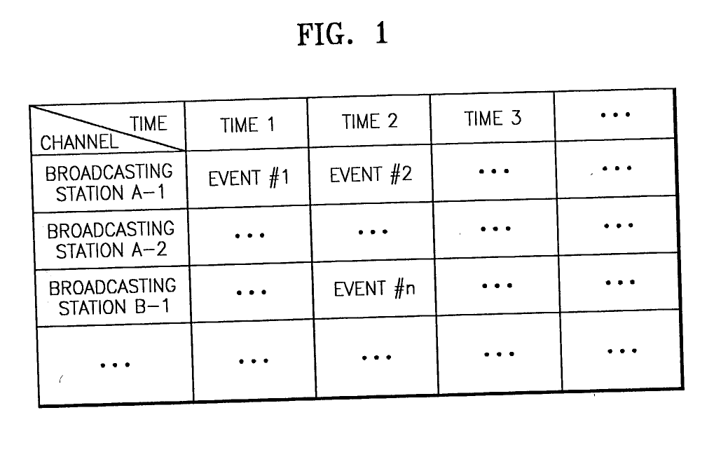

### DETAILED DESCRIPTION OF THE PREFERRED EMBODIMENT

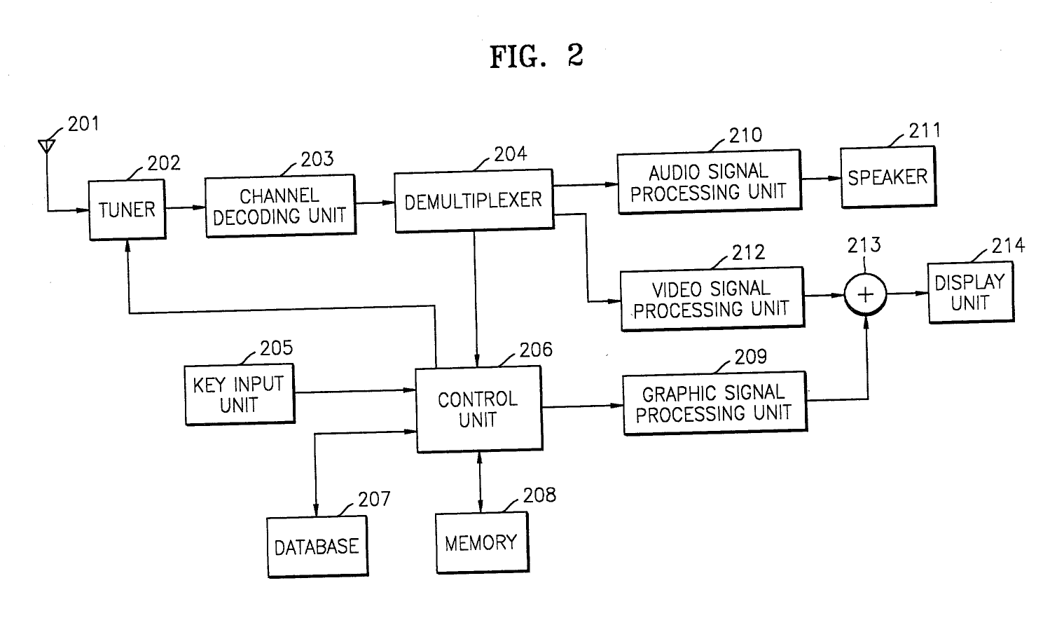

As shown in FIG. 2, a television receiver equipped with an apparatus for controlling the display of electronic program guide information includes an antenna 201, a tuner 202, a channel decoding unit 203, a demultiplexer 204, a key input unit 205, a control unit 206, a database 207, and a memory 208. The apparatus further includes a graphic signal processing unit 209, an audio signal processing unit 210, a speaker 211, a video signal processing unit 212, a mixer 213 and a display unit 214.

When a user selects a channel using a key button of the key input unit 205 after turning the television receiver on, the tuner 202 outputs the signal of the channel selected by the user from the signals received by the antenna 201 or at an input terminal. The channel decoding unit 203 restores the digital signal detected from the signal of the selected channel in units of packets and outputs the restored digital signal to the demultiplexer 204. The demultiplexer 204 separates the restored packet data into individual bit streams of audio data, video data and additional information data, and outputs the bit streams to audio signal processing unit 210 and video signal processing unit 212.

The separated audio data is decoded by the audio signal processing unit 210, converted into an analog signal and output through the speaker 211. Signal processes, such as decoding, error correction, and so on, are performed on the separated video data by the video signal processing unit 212. The decoded video data is mixed with an EPG graphic signal in the mixer 213, and output to the display unit 214 where it is displayed.

The electronic program guide information included in the additional information data separated by the demultiplexer 204 is input to the control unit 206 and processed as follows.

The control unit 206 determines if electronic program guide information included in the received additional information is new information which is not stored in the database 207. If the received electronic program guide information is determined to be new information, it is classified by sorting parameters and stored in the database 207. The sorting parameters include channel numbers, broadcasting station names, genres, rates, start time, playing time, program names and any other parameter of interest. If the received electronic program guide information is determined to be information which is already stored in the database 207 but includes some changes, the stored data is updated in accordance with the changes in the newly received data.

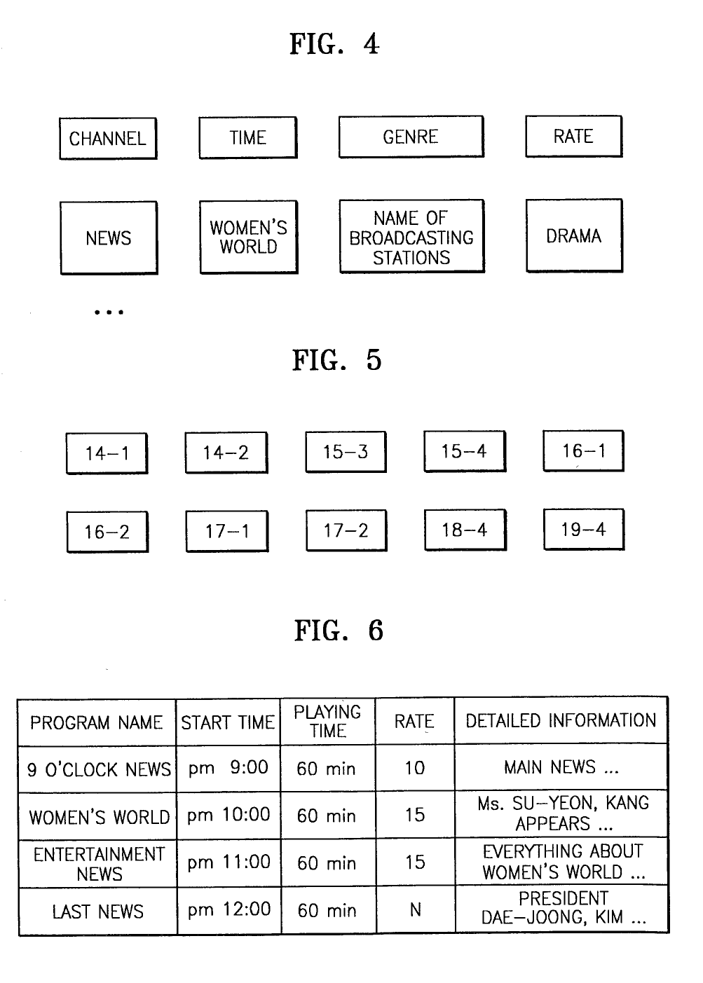

The control unit 206 includes programs for classification, distribution and management of files. Specifically, the control unit 206 manages the electronic program guide files stored in the database 207 in accordance with their classification, and displays the program guide files on, for example, the television screen in folders, with each folder representing a type of directory file. The programs are arranged so that a user can easily create folders in a directory file by using a key input unit 205, such as a remote controller. For example, the user can create folders for forming an EPG menu display like that shown in FIG. 4. Namely, the user can create a directory of an electronic program guide information menu folders such as channels, time, genres, rates, news, women's world, broadcasting station names, and drama, as well as any other desired folders.

It is also possible for the user to design a directory structure which includes sub-channel folders for each channel as shown, for example, in FIG. 5. It is also possible for the user to add or delete a directory or a file in accordance with the user's selection in the directory and the folder structure. Namely, if the user is greatly interested in a television drama named “Women's World”, the user can add a program guide information file “Women's World” as a menu display folder as shown in FIG. 4. When the user then selects the ‘Women's World’ folder on the program guide menu display, the control unit 206 reads out the guide information file about the drama “Women's World” from the memory 208.

That is, the memory 208 stores file data read out from the database 207 in the directory consisting of folders of the electronic program guide menu display designed by the user. The key input unit 205 includes keys to select, add, delete or make changes to the folders in the electronic program guide menu display.

The graphic signal processing unit 209 also includes hardware and software to display the electronic program guide information read out from the memory 208 in graphical format.

As described briefly above, the mixer 213 mixes video signals processed in the video signal processing unit 212 and electronic program guide graphic signals processed in the graphic signal processing unit 209, and outputs signals in OSD (On Screen Display) form.

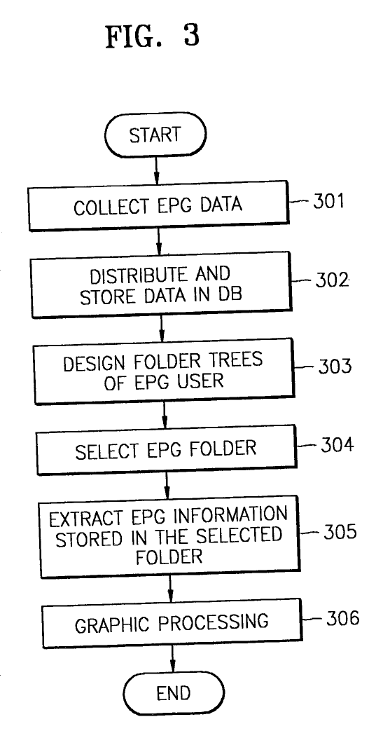

A method for controlling the display of electronic program guide information according to an embodiment of the present invention will be described in detail with reference to the flow chart of FIG. 3.

First, in step 301, the control unit 206 collects electronic program guide data included in the additional information received by the demultiplexer 204.

Next, if the collected electronic program guide data is determined to be new information which is not stored in the database 207, it is classified in accordance with sorting parameters and stored in the database 207. If the received electronic program guide information is determined to be information which is already stored in the database 207 but includes some changes, the stored data is updated according to the changes in the newly received data in step 302.

In step 303, the user can design and arrange folders in a folder and a directory structure in the electronic program guide menu display as shown in FIG. 4. Namely, the user selects folders corresponding to a main directory from the electronic guide information menu display, and then can design sub-folders for each folder shown in FIG. 4. For example, the user can create detailed channel folders in the “channel” folder directory as shown in FIG. 5. It is also possible for a user to add or delete channel folders. The program guide data relating to folders in the directory designed in the manner described above is stored in the memory 208 such that the program guide data is associated with its respective folder.

When a user inputs an EPG menu using the key input unit 205 to obtain program guide information, an EPG menu having one or more folders is displayed on the display as shown in FIG. 4. The user can then simply select a folder including EPG information the user wishes to view in step 304. The electronic program guide data stored in the file relating to the selected folder is then read out from the memory 208 in step 305.

For example, if a user selects the “channel” folder (see FIG. 4) in the EPG menu display in step 304, and channel sub-folder “17-1” (see FIG. 5) out of the channel sub-folders in the directory, the control unit 206 reads out electronic program guide data related to channel “17-1” from the memory 208.

The electronic program guide data related to channel “17-1” retrieved from the memory 208 is converted in the graphic signal processing unit 209 into a graphical signal for display in step 306, and output to the on-screen display which displays the electronic program guide as shown in FIG. 6. The user can then view the electronic program guide as desired.

As described above, the disclosed embodiment of the present invention is designed so the user can organize electronic program guide information into a directory of organized folders, such as a window type file system, so that the user can display electronic program guide information selected in accordance with the user's preferences. Therefore, the present invention allows a user to conveniently access and view electronic program guide information.

Further, the embodiment of the present invention described above can be realized as a method, an apparatus or system, and as software such as code segments for performing the operations described above. It is possible that the programs or code segments can be stored on readable material and be transmitted by computer data signals embodied in a carrier signal being transmitted in a transmission medium, or over a communication network. It is noted that processor-readable material includes all material which is capable of storing or transmitting information. Processor-readable material includes electronic circuits, semiconductor memory devices, ROMs, flash memory, E²PROMs, floppy disks, optical disks, hard disks, optical fiber material, wireless radio frequency (RF) networks, and so on. Computer data signals include any signal which can be transmitted on transmission mediums such as electronic network channels, optical fibers, the air, electromagnetic fields, radio frequency networks, and so on.

While this invention has been particularly shown and described with reference to a preferred embodiment thereof, the preferred embodiment described above is merely illustrative and not intended to limit the scope of the invention. It will be understood by those skilled in the art that various changes in form and details may be made therein without departing from the spirit and scope of the invention as defined by the appended claims. It is obvious that the present invention is not limited by a constitution or a disposition of the shown or described characteristics.

What is claimed is:

1. A method for controlling the display of electronic program guide (EPG) information, comprising:
classifying electronic program guide information to correspond to EPG folders assigned by a user, and storing the electronic program guide information in a memory;
extracting from the memory electronic program guide information included in the EPG folders selected from an EPG menu display; and
converting the electronic program guide information extracted in the extracting step into a predetermined graphic signal and outputting the predetermined graphical signal to a display.

2. The method of claim 1, wherein the classifying and storing step includes associating the EPG folders with respective EPG-related files as designated by the user using the EPG menu display.

3. The method of claim 1, further comprising:
enabling the user to search, add, delete or modify the EPG folders.

4. The method of claim 3, wherein the enabling step includes enabling the user to use the EPG menu display to search, add, delete or modify the EPG folders.

5. The method of claim 1, wherein the classifying and storing step includes further classifying the electronic program guide information corresponding to at least one EPG folder such that respective portions of the further classified electronic program guide information correspond to respective sub-folders assigned by the user.

6. The method of claim 1, further comprising:
prior to performing the extracting and converting steps, displaying the EPG menu display on the display based on the classified electronic program guide information.

7. The method of claim 1, further comprising:
displaying an EPG on the display based on the predetermined graphical signal.

8. The method of claim 1, further comprising:
modifying the electronic program guide information stored in the memory based on additional received electronic program guide information.

9. An apparatus for controlling the display of electronic program guide information, comprising:
a control unit, adapted to receive electronic program guide information and classify the electronic program guide information to correspond to EPG folders;
a database, adapted to store the electronic program guide information;
a memory, adapted to store the electronic program guide information after being classified by the control unit; and
a graphic signal processing unit; and
the control unit is further adapted to read from the memory file information corresponding to one of the EPG folders selected by a user, and the graphic signal processing unit is further adapted to generate a graphic signal corresponding to the electronic program guide information that is read from the memory by the control unit.

10. The apparatus of claim 9, wherein the control unit is further adapted to search, add, delete or modify the EPG folders as designated by the user.

11. The apparatus of claim 10, wherein the control unit enables the user to use the EPG menu display to search, add, delete or modify the EPG folders.

12. The apparatus of claim 9, wherein the control unit is further adapted to associate the EPG folders with respective EPG-related files as designated by the user via the EPG menu display.

13. The apparatus of claim 9, wherein the control unit is further adapted to classify the electronic program guide information corresponding to at least one EPG folder such that respective portions of the further classified electronic program guide information correspond to respective sub-folders assigned by the user.

14. The apparatus of claim 9, wherein the control unit is further adapted to display the EPG menu display on a display based on the classified electronic program guide information.

15. The apparatus of claim 9, wherein the control unit is further adapted to display an EPG on a display based on the predetermined graphical signal.

16. The apparatus of claim 9, wherein the control unit is further adapted to modify the electronic program guide information stored in the memory based on additional received electronic program guide information.

17. A computer-readable medium of instructions, adapted to control a television receiver to display electronic program guide (EPG) information, comprising:
a first set of instructions, adapted to control the television receiver to classify electronic program guide information to correspond to EPG folders assigned by a user, and to store the electronic program guide information in a memory;
a second set of instructions, adapted to control the television receiver to extract from the memory electronic program guide information included in the EPG folders selected from an EPG menu display; and
a third set of instructions, adapted to control the television receiver to convert the electronic program guide information extracted in the extracting step into a predetermined graphic signal and outputting the predetermined graphical signal to a display.

18. The computer-readable medium of instructions of claim 17, wherein the first set of instructions is further adapted to control the television receiver to classify the electronic program guide information by associating the EPG folders with respective EPG-related files as designated by the user using the EPG menu display.

19. The computer-readable medium of instructions of claim 17, further comprising:
a fourth set of instructions, adapted to control the television receiver to enable the user to search, add, delete or modify the EPG folders.

20. The computer-readable medium of instructions of claim 19, wherein the fourth set of instructions controls the television receiver to enable the user to use the EPG menu display to search, add, delete or modify the EPG folders.

21. The computer-readable medium of instructions of claim 17, wherein the first set of instructions is further adapted to control the television receiver to classify the electronic program guide information corresponding to at least one EPG folder such that respective portions of the further classified electronic program guide information correspond to respective sub-folders assigned by the user.

22. The computer-readable medium of instructions of claim 17, further comprising:
a fifth set of instructions, adapted to control the television receiver to display the EPG menu display on the display based on the classified electronic program guide information.

23. The computer-readable medium of instructions of claim 17, further comprising:
a sixth set of instructions, adapted to control the television receiver to display an EPG on the display based on the predetermined graphical signal.

24. The computer-readable medium of instructions of claim 17, further comprising:
a seventh set of instructions, adapted to control the television receiver to modify the electronic program guide information stored in the memory based on additional received electronic program guide information.
